(19) United States
(12) Patent Application Publication
(10) Pub. No.: US 2024/0329372 A1
(43) Pub. Date: Oct. 3, 2024

(54) ZOOM LENS AND IMAGE PICKUP APPARATUS HAVING THE SAME

(71) Applicant: CANON KABUSHIKI KAISHA, Tokyo (JP)

(72) Inventor: Shinichiro SAITO, Tochigi (JP)

(21) Appl. No.: 18/596,701

(22) Filed: Mar. 6, 2024

(30) Foreign Application Priority Data
Apr. 3, 2023 (JP) 2023-060157

(51) Int. Cl. G02B 15/14

(52) U.S. Cl. CPC G02B 15/1461

(57) ABSTRACT

A zoom lens includes four or more lenses that include, in order from an object side to an image side, a first lens unit having positive refractive power, a second lens unit having negative refractive power, and a third lens unit having positive refractive power. A distance between adjacent lens units changes during zooming from a wide-angle end to a telephoto end. For zooming from the wide-angle end to the telephoto end, the first lens unit and the third lens unit are fixed relative to an image plane, and the second lens unit moves toward the image side. The third lens unit includes three lens elements each having positive refractive power. Predetermined inequalities are satisfied.

### BACKGROUND

### Technical Field

One of the aspects of the embodiments relates to a zoom lens, which is suitable for an imaging optical system in an image pickup apparatus such as a digital still camera, a digital video camera, a broadcasting camera, a surveillance camera, an on-board camera (in-vehicle camera), and a film-based camera.

### Description of Related Art

Recently, zoom lenses for image pickup apparatuses have been strongly demanded to have high optical performance, a small size, and a high magnification variation ratio as a whole. For optical performance improvement and size reduction of the entire zoom lens, properly setting the refractive power and configuration of each lens unit, the moving condition for each lens unit during zooming, and the like is important.

Particularly, both size reduction and chromatic aberration correction are required to improve a magnification variation ratio in a camera that includes a large image sensor.

Japanese Patent Laid-Open No. 2019-124818 discloses a zoom lens that includes five or more lens units including four lens units as positive, negative, positive, and negative lenses arranged in order from the object side, wherein the fourth lens unit serves as a focus lens unit so as to achieve a telephoto configuration.

The zoom lens disclosed in Japanese Patent Laid-Open No. 2019-124818 can reduce the size of the zoom lens and suppress various aberrations in the telephoto range by enhancing the refractive powers of the first lens unit and the second lens unit but has difficulty in achieving a wide-angle configuration.

### SUMMARY

A zoom lens according to one aspect of the disclosure includes four or more lenses that include, in order from an object side to an image side, a first lens unit having positive refractive power, a second lens unit having negative refractive power, and a third lens unit having positive refractive power. A distance between adjacent lens units changes during zooming from a wide-angle end to a telephoto end. For zooming from the wide-angle end to the telephoto end, the first lens unit and the third lens unit are fixed relative to an image plane, and the second lens unit moves toward the image side. The third lens unit includes three lens elements each having positive refractive power. The following inequalities are satisfied:

0.005<f3/ft<0.150

1.902<nd3u<2.300

−0.50<β2w<−0.01

where f3 is a focal length of the third lens unit, ft is a focal length of the zoom lens at the telephoto end, nd3u is a maximum value among refractive indices for d-line of lenses included in the third lens unit, and β2w is a lateral magnification of the second lens at the wide-angle end. An image pickup apparatus having the above zoom lens also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 illustrates sectional views of a zoom lens according to Example 1 at a wide-angle end, an intermediate zoom position, and a telephoto end.

FIGS. 2A, 2B, and 2C are aberration diagrams of the zoom lens according to Example 1 at the wide-angle end, the intermediate zoom position, and the telephoto end, respectively.

FIG. 3 illustrates sectional views of a zoom lens according to Example 2 at a wide-angle end, an intermediate zoom position, and a telephoto end.

FIGS. 4A, 4B, and 4C are aberration diagrams of the zoom lens according to Example 2 at the wide-angle end, the intermediate zoom position, and the telephoto end, respectively.

FIG. 5 illustrates sectional views of a zoom lens according to Example 3 at a wide-angle end, an intermediate zoom position, and a telephoto end.

FIGS. 6A, 6B, and 6C are aberration diagrams of the zoom lens according to Example 3 at the wide-angle end, the intermediate zoom position, and the telephoto end, respectively.

FIG. 7 illustrates sectional views of a zoom lens according to Example 4 at a wide-angle end, an intermediate zoom position, and a telephoto end.

FIGS. 8A, 8B, and 8C are aberration diagrams of the zoom lens according to Example 4 at the wide-angle end, the intermediate zoom position, and the telephoto end, respectively.

FIG. 9 illustrates sectional views of a zoom lens according to Example 5 at a wide-angle end, an intermediate zoom position, and a telephoto end.

FIGS. 10A, 10B, and 10C are aberration diagrams of the zoom lens according to Example 5 at the wide-angle end, the intermediate zoom position, and the telephoto end, respectively.

FIG. 11 is a schematic diagram of an image pickup apparatus.

### DESCRIPTION OF THE EMBODIMENTS

Referring now to the accompanying drawings, a description will be given of a zoom lens according to each example, an image pickup apparatus having the same, and an imaging system having the same.

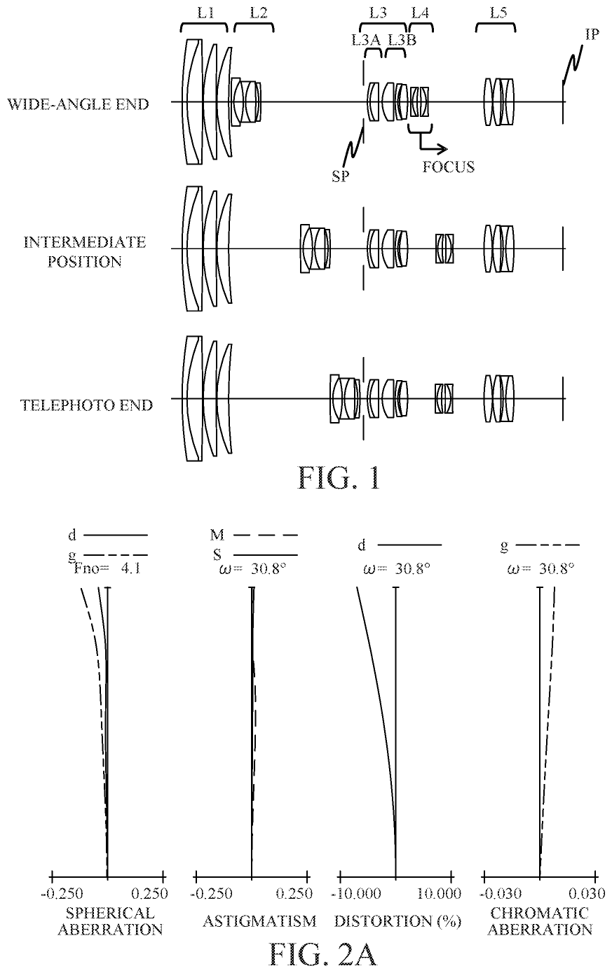

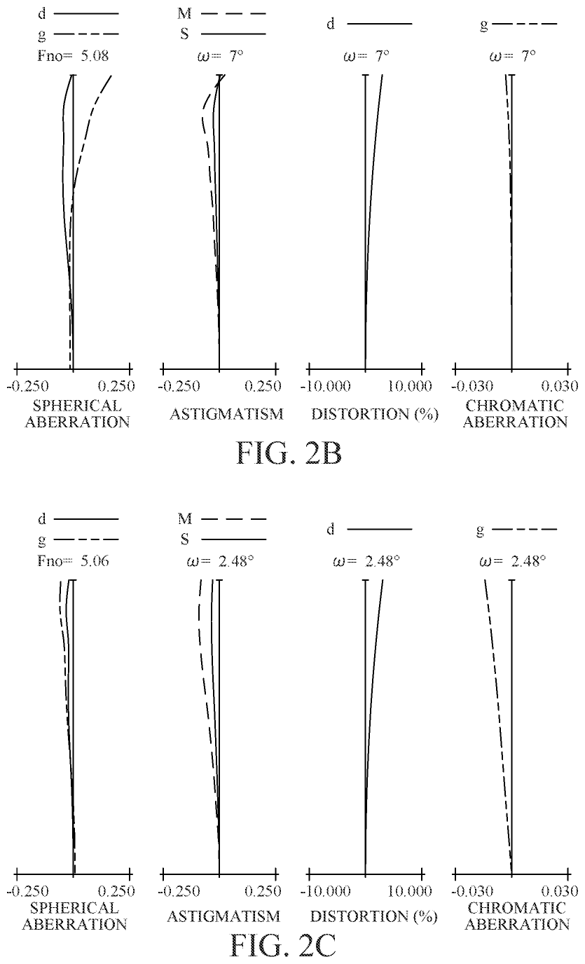

FIG. 1 illustrates sectional views of a zoom lens according to Example 1 at a wide-angle end (short focal length end), an intermediate zoom position (or middle zoom position), and a telephoto end (long focal length end). FIGS. 2A, 2B, and 2C are aberration diagrams of the zoom lens according to Example 1 at the wide-angle end, the intermediate zoom position, and the telephoto end, respectively. The zoom lens according to Example 1 has a zoom ratio of 13.5 and an aperture ratio of about 4.1 to 5.1.

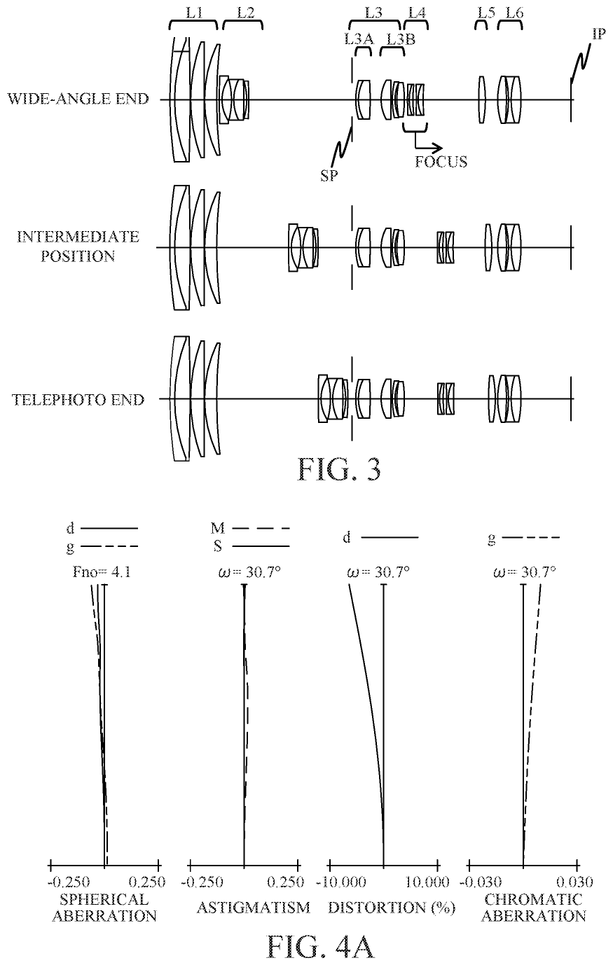

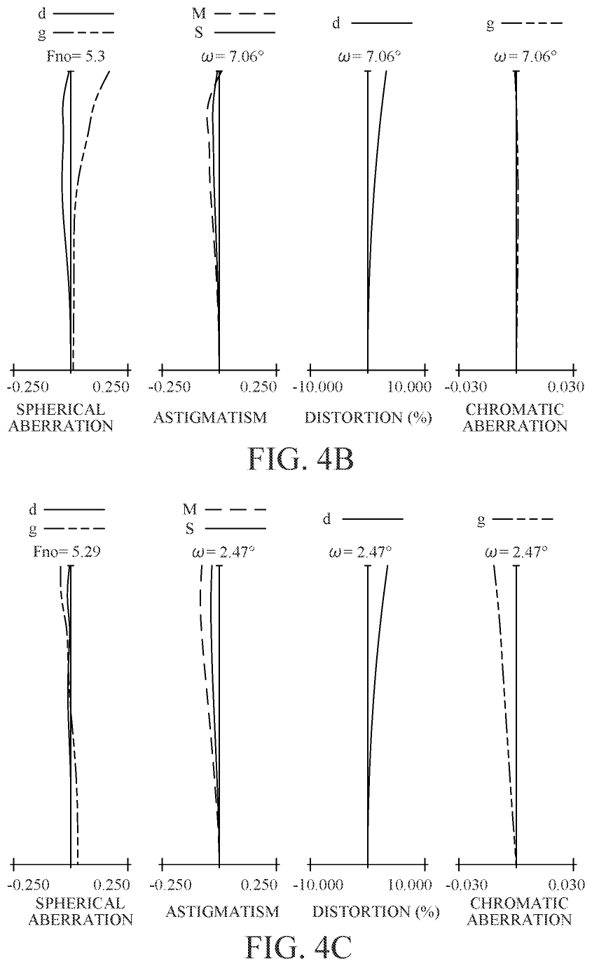

FIG. 3 illustrates sectional views of a zoom lens according to Example 2 at a wide-angle end, an intermediate zoom position, and a telephoto end. FIGS. 4A, 4B, and 4C are aberration diagrams of the zoom lens according to Example 2 at the wide-angle end, the intermediate zoom position, and the telephoto end, respectively. The zoom lens according to Example 2 has a zoom ratio of 13.5 and an aperture ratio of about 4.1 to 5.3.

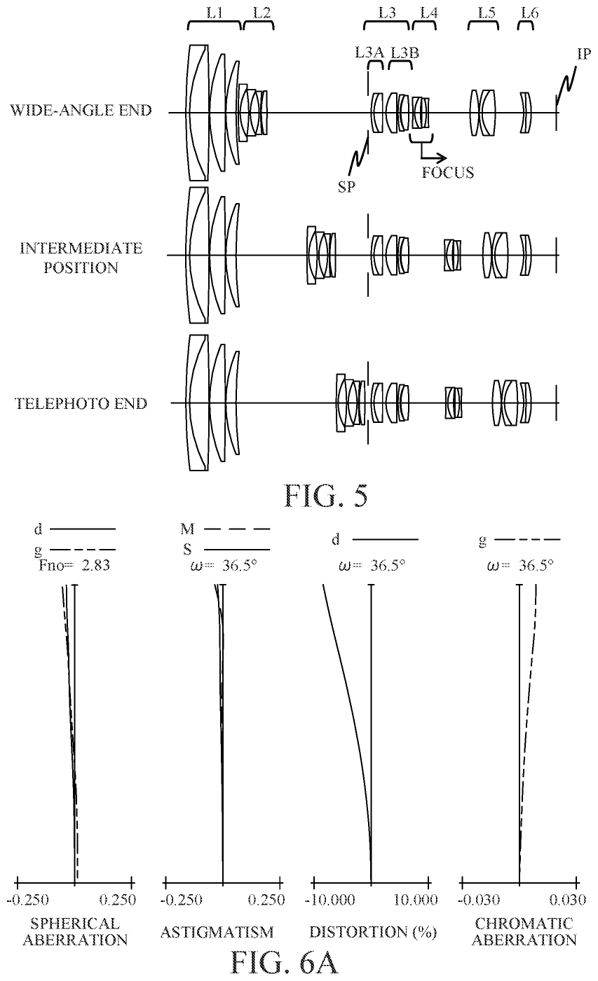

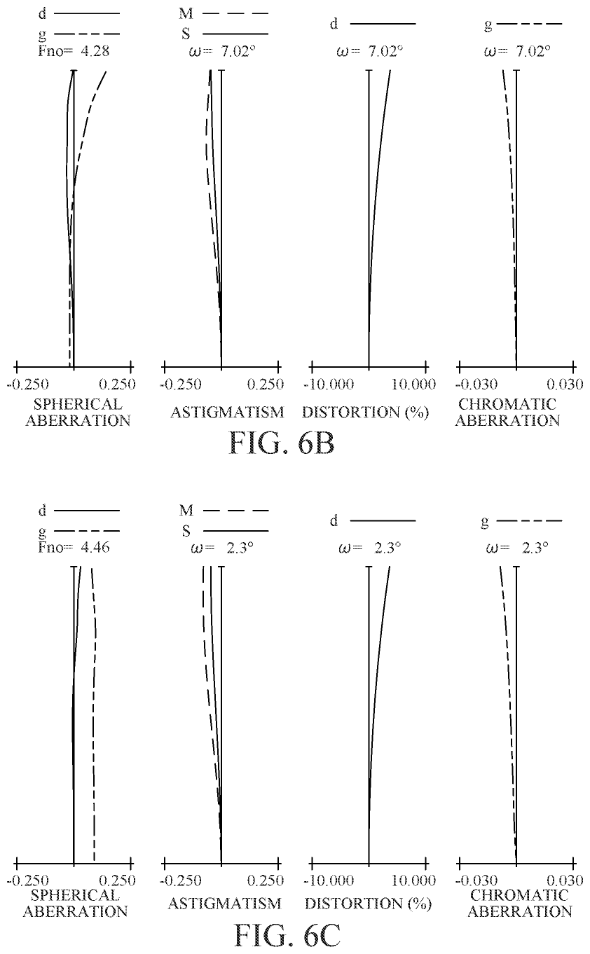

FIG. 5 illustrates sectional views of a zoom lens according to Example 3 at a wide-angle end, an intermediate zoom position, and a telephoto end. FIGS. 6A, 6B, and 6C are aberration diagrams of the zoom lens according to Example 3 at the wide-angle end, the intermediate zoom position, and the telephoto end, respectively. The zoom lens according to Example 3 has a zoom ratio of 17.2 and an aperture ratio of about 2.8 to 4.5.

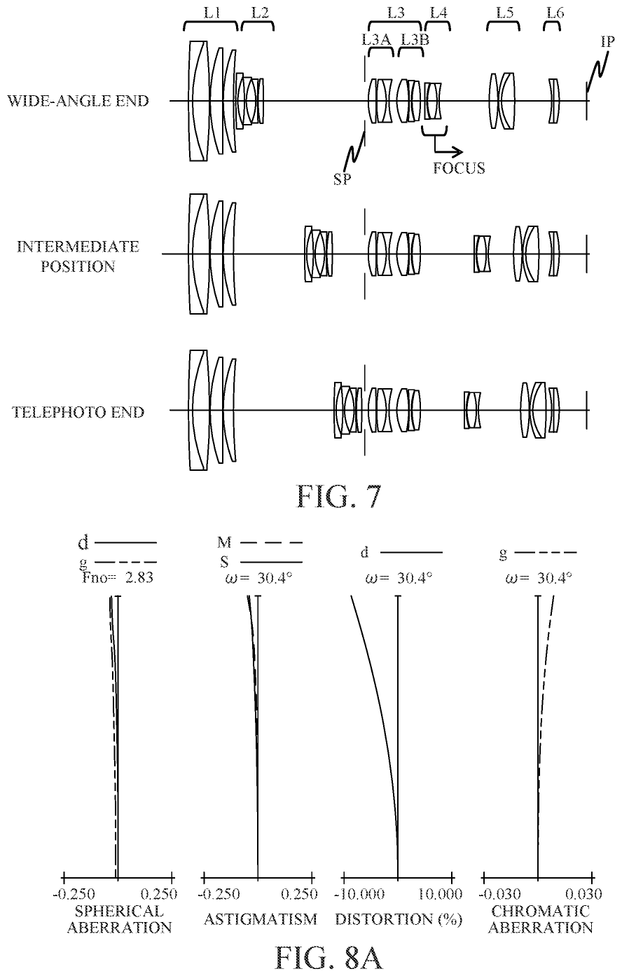

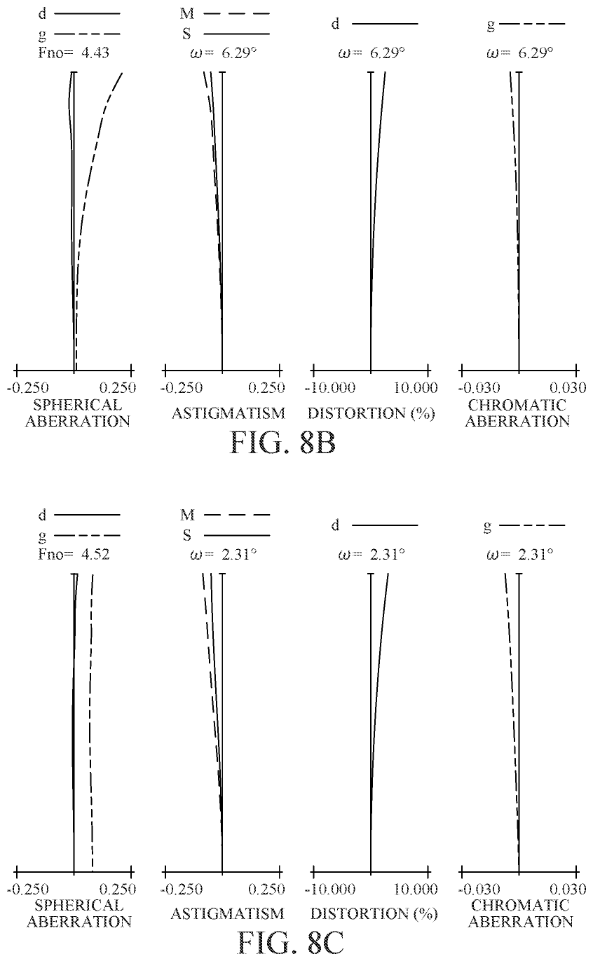

FIG. 7 illustrates sectional views of the zoom lens according to Example 4 at a wide-angle end, an intermediate zoom position, and a telephoto end. FIGS. 8A, 8B, and 8C are aberration diagrams of the zoom lens according to Example 4 at the wide-angle end, the intermediate zoom position, and the telephoto end, respectively. The zoom lens according to Example 4 has a zoom ratio of 14.8 and an aperture ratio of about 2.8 to 4.5.

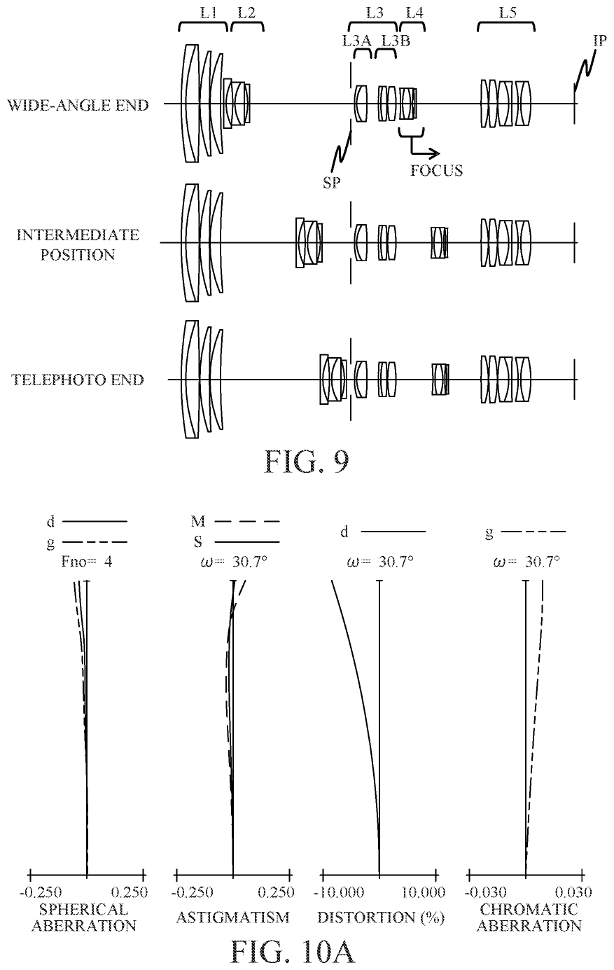

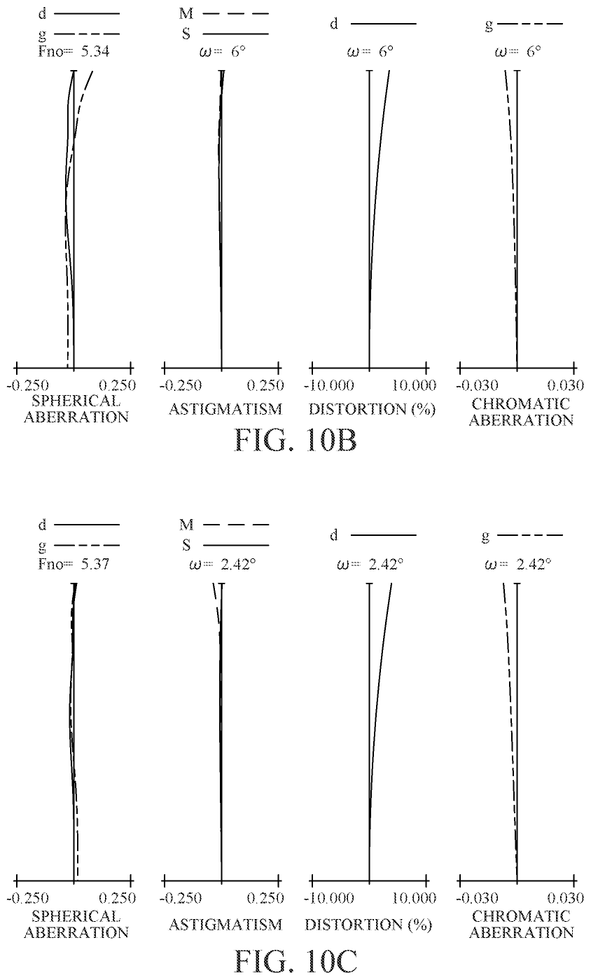

FIG. 9 illustrates sectional views of a zoom lens according to Example 5 at a wide-angle end, an intermediate zoom position, and a telephoto end. FIGS. 10A, 10B, and 10C are aberration diagrams of the zoom lens according to Example 5 at the wide-angle end, the intermediate zoom position, and the telephoto end, respectively. The zoom lens according to Example 5 has a zoom ratio of 14.0 and an aperture ratio of about 4.0 to 5.4.

The zoom lens according to each example is a zoom lens for an image pickup apparatus such as a digital still camera, a film-based camera, a digital video camera, a surveillance camera, a broadcasting camera, and an on-board (in-vehicle) camera. The zoom lens according to each example can also be used as a projection optical system for a projection device (projector).

In each lens sectional view, a left side is an object side (front) and a right side is an image side (back). The zoom lens according to each example includes a plurality of lens units. In this specification, a lens unit is a group of lenses that move or stand still during zooming. That is, in the zoom lens according to each example, the distance between adjacent lens units changes during zooming from the wide-angle end to the telephoto end. The lens unit includes one or more lenses. The lens unit may include an aperture stop.

In each lens sectional view, Li represents an i-th lens unit (where i is a natural number) counting from the object side of the zoom lens.

SP is an aperture stop (diaphragm) that determines (restricts) a light beam (luminous flux) of the open F-number (Fno). IP represents an image plane. In a case where the zoom lens according to each example is used as an imaging optical system for a digital still camera or video camera, an imaging surface of a solid-state image sensor (photoelectric conversion element) such as a CCD sensor or CMOS sensor is disposed on the image plane IP. In a case where the zoom lens according to each example is used as an imaging optical system in a film-based camera, a photosensitive surface corresponding to a film surface is placed on the image plane IP.

An arrow regarding focus indicates a moving direction of the lens unit during focusing from infinity to a close (or short) distance.

In each of the following examples, the wide-angle end and the telephoto end refer to zoom positions in a case where the zooming lens unit is mechanically located at both ends of a movable range on the optical axis.

In the spherical aberration diagram, Fno represents an F-number. The spherical aberration diagram illustrates spherical aberration amounts for the d-line (wavelength 587.56 nm) and the g-line (wavelength 435.84 nm). In the astigmatism diagram, S represents an astigmatism amount on a sagittal image plane for the d-line, and M indicates an astigmatism amount on a meridional image surface for the d-line. The distortion diagram illustrates a distortion amount for the d-line. The chromatic aberration diagram illustrates a chromatic aberration amount for the g-line. ω represents an imaging half angle of view (°), which indicates an angle of view based on a ray tracing value.

A description will now be given of the characteristic configuration of the zoom lens according to each example.

The zoom lens according to each example includes four or more lens units. The four or more lens units include, in order from the object side to the image side, a first lens unit L1 having positive refractive power, a second lens unit L2 having negative refractive power, and a third lens unit L3 having positive refractive power. Here, the refractive power is optical power that is a reciprocal of focal length.

In the zoom lens according to each example, a distance between adjacent lens units changes during zooming from the wide-angle end to the telephoto end. For zooming from the wide-angle end to the telephoto end, the first lens unit L1 and the third lens unit L3 do not move (are fixed) relative to the image plane IP. For zooming from the wide-angle end to the telephoto end, the second lens unit L2 moves so that the distance between the first lens unit L1 and the second lens unit L2 widens, and the distance between the second lens unit L2 and the third lens unit L3 narrows. That is, for zooming from the wide-angle end to the telephoto end, the second lens unit moves toward the image side.

The third lens unit L3 includes three lens elements each having positive refractive power. Here, the lens element refers to a single lens, a cemented lens consisting of a positive lens and a negative lens, a replica lens formed by molding an ultraviolet curing resin into an aspherical shape on a single lens, etc.

The zoom lens according to each example satisfies the following inequalities (1) to (3):

0.005<f3/ft<0.150 (1)

1.902<nd3u<2.300 (2)

−0.50<β2w<−0.01 (3)

where f3 is a focal length of the third lens unit L3, and ft is a focal length of the zoom lens at the telephoto end, nd3u is a maximum value of the refractive indices for the d-line of lenses included in the third lens unit L3, and β2W is a lateral magnification of the second lens unit L2 at the wide-angle end.

The zoom lens according to each example includes, in order from the object side, three lens units having positive, negative, and positive refractive powers in order to reduce the overall lens length and satisfactorily correct aberrations over the entire zoom range. The configuration having at least four lens units can effectively correct spherical aberration and coma that would occur in the first lens unit L1 and the second lens unit L2. In the telephoto side range, variations in spherical aberration and coma become large due to manufacturing errors. Therefore, a so-called positive lead zoom type in which the first lens unit L1 has positive refractive power can suppress the incident height of the on-axis ray on each lens element on the image side of the second lens unit L2. This configuration can satisfactorily correct various aberrations such as chromatic aberration and spherical aberration over the entire zoom range while reducing the size of the zoom lens.

In order to secure a reduced size and a high zoom ratio, zooming is performed by changing the distance between adjacent lens units so that the distance between the first lens unit L1 and the second lens unit L2 at the telephoto end becomes wider than that at the wide-angle end, and the distance between the second lens unit L2 and the third lens unit L3 at the telephoto end becomes narrower than that at the wide-angle end.

Fixing the first lens unit L1 relative to the image plane IP for zooming can maintain high positional accuracy and eliminate changes in the overall length during zooming. In addition, this configuration can reduce the number of movable lens units during zooming, simplify mechanical parts, and reduce the cost. Simplification of mechanical parts can suppress dust and the like. Furthermore, strength may be secured in a case where an accessory is attached such as a front filter and a converter lens.

Fixing the third lens unit L3 relative to the image plane IP for zooming can easily secure the eccentric position accuracy of the third lens unit L3, which is a problem in increasing the aperture diameter or reducing the overall length, and can suppress eccentric coma. Moreover, the number of movable lens units during zooming can be reduced, the overall system can become smaller, the configuration can become simple, and the imaging performance of the entire system can be easily secured.

The third lens unit L3 includes three lens elements having positive refractive power. These three lens elements each having positive refractive power will be referred to as a first positive lens element, a second positive lens element, and a third positive lens element in order from the object side. This configuration can reduce the overall lens length while suppressing fluctuations in spherical aberration and coma due to zooming. In the third lens unit L3, the first positive lens element disposed closest to the object has a function of reducing the divergence of the incident on-axis light beam from the second lens unit L2 to the third lens unit L3. This configuration can suppress the ray height within the third lens unit L3, and suppress higher-order spherical aberrations and eccentric coma. The second positive lens element suppresses fluctuations in spherical aberration and coma due to zooming, and the third positive lens element corrects off-axis coma in the wide-angle range and curvature of field from the intermediate zoom range to the telephoto range.

At least one of the lens elements each having positive refractive power in the third lens unit L3 may be a cemented lens. This configuration can easily suppress variations in spherical aberration and coma for each wavelength, which are a problem in increasing the aperture diameter. The first positive lens element disposed closest to the object among the three lens elements each having positive refractive power in the third lens unit L3 may be a cemented lens that consists of a negative lens and a positive lens arranged in order from the object side to the image side. This configuration can easily correct spherical aberration and coma in the telephoto range. In addition, this configuration can compensate for insufficient correction of various aberrations caused by the selection of glass materials, and suppress various aberrations without using many aspheric lenses.

Inequality (1) defines a focal length of the third lens unit L3 by the focal length of the zoom lens at the telephoto end, so as to correct coma and curvature of field in the telephoto range and reduce the overall lens length. In a case where the value becomes higher than the upper limit of inequality (1), the refractive power of the third lens unit L3 becomes weak, and the curvature of field in the telephoto range tends to be large. The convergence effect of the third lens unit L3 becomes weak, and the overall lens length becomes long. In a case where the value becomes lower than the lower limit of inequality (1), the refractive power of the third lens unit L3 becomes too strong, the incident on-axis light beam becomes a strongly convergent beam, and coma changes relative to the image height in the telephoto range.

Inequality (2) defines the maximum value of the refractive indices for the d-line of the lenses included in the third lens unit L3. In a case where the value becomes higher than the upper limit of inequality (2) and the third lens unit L3 has a high refractive index, the radius of curvature of the third lens unit L3 becomes large, and various aberrations, especially distortion cannot be effectively corrected at the wide-angle end. In a case where the refractive index of the third lens unit L3 becomes lower than the lower limit of inequality (2), the radius of curvature of the third lens unit L3 becomes small in order to provide a predetermined refractive power, and it becomes difficult to correct spherical aberration. In particular, as the magnification variation ratio increases, fluctuations in spherical aberration during zooming increase, and the refractive power of the second lens unit L2 is to be suppressed in order to suppress the fluctuations. Thereby, a moving amount of the second lens unit L2 is to increase in order to achieve the desired zoom ratio, and the overall length of the lens becomes longer.

Inequality (3) defines a range of the lateral magnification (imaging magnification) of the second lens unit L2 at the wide-angle end. In a case where the value becomes higher than the upper limit of inequality (3), the lateral magnification of the second lens unit L2 at the wide-angle end becomes too large, the focal length of the entire lens system becomes closer to the telephoto side, and it becomes difficult to obtain the desired magnification variation ratio. The value lower than the lower limit of inequality (3) is beneficial to a high magnification variation ratio, but the focal length of the entire lens system becomes closer to the wide-angle end, the lens closest to the object of the first lens unit L1 becomes large in the diameter direction, and the entire lens system becomes large. Satisfying inequality (3) can secure a desired magnification variation ratio, and reduce the size of the entire lens system.

Inequalities (1), (2), and (3) may be replaced with inequalities (1a), (2a), and (3a) below:

0.050<f3/ft<0.147 (1a)

1.902<nd3u<2.150 (2a)

−0.39<β2w<−0.11 (3a)

Satisfying inequality (1a) can easily suppress spherical aberration and coma while easily suppressing longitudinal chromatic aberration in the telephoto range.

Satisfying inequality (2a) can reduce the overall lens length while suppressing variations in off-axis coma for each image height in the telephoto range and variations in coma that would occur during zooming.

Satisfying inequality (3a) can satisfactorily correct various aberrations and secure a high magnification variation ratio.

Inequalities (1), (2), and (3) may be replaced with inequalities (1b), (2b), and (3b) below:

0.100<f3/ft<0.145 (1b)

1.903<nd3u<2.060 (2b)

−0.28<β2w<−0.22 (3b)

As described above, properly setting the configuration of each lens unit and satisfying inequalities (1), (2), and (3) at the same time can provide a zoom lens that has a high optical performance, a small size, and a high magnification variation ratio by suppressing variations in spherical aberration for each wavelength etc. and maintaining a wide angle of view.

Next follows conditions that may be satisfied by the zoom lens according to each example. The zoom lens according to each example may satisfy one or more of the following inequalities (4) to (14).

Here, fw is a focal length of the zoom lens at the wide-angle end, f1 is a focal length of the first lens unit L1, and f2 is a focal length of the second lens unit L2. β2t is a lateral magnification of the second lens unit L2 at the telephoto end. SF3u is a shape factor of lens u having the maximum refractive index for the d-line among the lenses included in the third lens unit. TDw is an overall lens length of the zoom lens at the wide-angle end. Here, the overall lens length is a distance on the optical axis from a lens surface on the object side of the lens disposed closest to the object to a lens surface on the image side of the lens disposed closest to the image plane in the zoom lens. The third lens unit L3 consists of, in order from the object side to the image side, a 3A subunit L3A (first subunit) and a 3B subunit L3B (second subunit) that are spaced via the largest air gap. At this time, f3A is a focal length of the 3A subunit L3A, and f3B is a focal length of the 3B subunit L3B. β3t is a lateral magnification of the 3B subunit L3B at the telephoto end, and βRt is a combined lateral magnification of the lenses disposed on the image side of the 3B subunit L3B. At this time, image shift sensitivity TS3Bt of the 3B subunit L3B at the telephoto end is defined as TS3Bt=β3t×(1−βRt). nd3PA is an average value of the refractive indices for the d-line of all positive lenses included in the third lens unit L3. νd3PA is an average value of the Abbe numbers of all positive lenses included in the third lens unit L3. skt is a back focus of the zoom lens at the telephoto end, where the back focus is a distance on the optical axis from a lens surface closest to the image plane to the image plane IP. In a case where an optical member having extremely low refractive power is disposed between the zoom lens and the image sensor, the back focus value will be calculated based on the air equivalent of the optical member having the extremely low refractive power disposed between the zoom lens and the image sensor.

The Abbe number νd and the partial dispersion ratio θgF is expressed as follows:

νd=(Nd−1)/(NF−NC)

θgF=(Ng−NF)/(NF−NC)

where Nd, NF, NC, and Ng are refractive indices for the d-line (587.6 nm), the F-line (486.1 nm), the C-line (656.3 nm), and the g-line in the Fraunhofer line.

The shape factor SF is a shape factor of the lens L, and is defined by the following equation:

SF=sgn(fL)×(R2+R1)/(R2−R1)

where fL is a focal length of the lens L, R1 is a radius of curvature of the lens surface on the object side, and R2 is a radius of curvature of the lens surface on image side. In the case of an aspherical shape, it means its base R (radius of a reference quadratic curved surface). sgn means a sign function, and takes +1 when fL has a positive value and −1 when fL has a negative value.

5.5<β2t/β2w<12.0 (4)

0.4<SF3u<8.0 (5)

8.0<TDw/fw<19.0 (6)

1.2<f3A/f3B<9.0 (7)

1.7<TS3Bt<4.0 (8)

1.8<f1/f3<4.7 (9)

1.47<nd3PA<1.71 (10)

48<νd3PA<85 (11)

0.01<|f2/ft|<0.15 (12)

4.5<|f1/f2|<10.0 (13)

0.01<skt/ft<0.25 (14)

Inequality (4) defines a ratio of the lateral magnification of the second lens unit L2 during zooming from the wide-angle end to the telephoto end, and is a condition for securing a high magnification variation ratio. In a case where the value becomes higher than the upper limit of inequality (4), image plane fluctuations during zooming increase, and it becomes difficult to maintain high optical performance. In a case where the value becomes lower than the lower limit of inequality (4), the magnification varying effect of the second lens unit L2 is small, the magnification varying effect is to be secured at the fourth lens unit L4, it becomes difficult to suppresses lateral chromatic aberration and distortion in the telephoto range, and the size reduction becomes difficult.

Inequality (5) defines the shape factor of the lens u that has the maximum refractive index for the d-line among the lenses included in the third lens unit L3 so as to satisfactorily correct spherical aberration and coma in a wide-angle range. In a case where the value of inequality (5) is 1 and the lens u has a negative refractive index, the lens u has a plano-concave shape with the concave surface facing the image side. In a case where the value becomes higher than the upper limit of inequality (5), it becomes difficult to satisfactorily correct spherical aberration on the wide-angle side, and coma that occurs when the lens u is decentered increases. In a case where the value becomes lower than the lower limit of inequality (5), the spherical aberration and longitudinal chromatic aberration in the telephoto range become large.

Inequality (6) defines the overall lens length of the zoom lens at the wide-angle end by the focal length of the zoom lens at the wide-angle end. Widening an angle of view in a zoom lens in which the first lens unit L1 is fixed relative to the image plane IP for zooming increases the front lens diameter, and it becomes difficult to achieve the size reduction. Therefore, the ratio of the overall lens length at the wide-angle end to the focal length at the wide-angle end defines a condition for reducing the overall lens length while satisfactorily correcting various aberrations. In a case where the value becomes higher than the upper limit of inequality (6), the overall lens length increases. This configuration is beneficial to corrections of distortion and curvature of field, but the front lens diameter increases and it becomes difficult to achieve both the size reduction and a high magnification variation ratio. In a case where the value becomes lower than the lower limit of inequality (6), the overall lens length becomes short, it becomes difficult to correct distortion and curvature of field in a wide-angle range, and the number of lenses increases.

Inequality (7) defines a ratio of the focal length of the 3A subunit L3A to the focal length of the 3B subunit L3B in order to reduce spherical aberration and coma over the entire zoom range while reducing the size of the entire system. Increasing the refractive power of the 3B subunit L3B to a certain extent relative to that of the 3A subunit L3A can easily suppress eccentric aberrations of the lenses disposed in the third lens unit L3. In a case where the value becomes higher than the upper limit of inequality (7), the divergence of the light beam exiting from the 3A subunit L3A becomes strong, and it becomes difficult to suppress spherical aberration and longitudinal chromatic aberration. In a case where the value becomes lower than the lower limit of inequality (7), the refractive power of the 3A subunit L3A becomes strong, and coma occurs in a wide-angle range.

Inequality (8) defines the image shift sensitivity during image stabilization of the 3B subunit L3B. Here, the image shift sensitivity TS is defined as a ratio of a moving amount ΔL of the shift unit (image stabilizing unit) in a direction orthogonal to the optical axis in a case where the shift unit is moved in that direction to a moving amount ΔI of an image (imaging position) on the image plane IP at that time in the direction orthogonal to the optical axis, that is, TS=ΔI/ΔL. In a case where the value becomes higher than the upper limit of inequality (8), the moving amount of the 3B subunit L3B required to shift the image by a predetermined amount increases, and it becomes difficult to reduce the size of the entire system. In addition, it becomes difficult to suppress aberration fluctuations in a case where the 3B subunit L3B is shifted in order to shift the image by the predetermined amount. In a case where the value becomes lower than the lower limit of inequality (8), an image significantly shifts in response to a fine movement of the 3B subunit L3B, and image displacement control with high accuracy is required.

Inequality (9) defines a ratio of the focal length of the first lens unit L1 to the focal length of the third lens unit L3 to achieve a high magnification variation ratio while satisfactorily suppressing spherical aberration and coma. In a case where the value becomes higher than the upper limit of inequality (9), the refractive power of the first lens unit L1 becomes small, and it becomes difficult to reduce the overall lens length. Furthermore, it becomes difficult to achieve a high zoom ratio. In a case where the value becomes lower than the lower limit of inequality (9), the refractive power of the first lens unit L1 becomes large, which is beneficial to widening an angle of view, but it is difficult to correct spherical aberration and coma.

Inequality (10) defines the refractive index of the positive lens included in the third lens unit L3 to satisfactorily correct spherical aberration and coma. In a case where the refractive index of the material for the positive lens becomes higher than the upper limit of inequality (10), it is beneficial to correcting various aberrations, but the Abbe number becomes insufficient, and it becomes difficult to correct longitudinal chromatic aberration, lateral chromatic aberration, in particular, the secondary spectrum. In an attempt to secure the desired performance, the size of the entire system and the number of lenses increase. In a case where the refractive index of the material for the positive lens becomes lower than the lower limit of inequality (10), it is beneficial to correcting longitudinal chromatic aberration, but it becomes difficult to correct curvature of field and distortion.

Inequality (11) defines the Abbe number of the positive lens included in the third lens unit L3 to suppress longitudinal chromatic aberration and compensate for insufficient chromatic aberration corrections in the first lens unit L1 and second lens unit L2. In a case where the value becomes higher than the upper limit of inequality (11), it is beneficial to correcting longitudinal chromatic aberration, but it becomes difficult to secure the desired refractive power as a glass material. In a case where the value becomes lower than the lower limit of inequality (11), first-order achromatizations of longitudinal chromatic aberration and lateral chromatic aberration become difficult.

Inequality (12) defines the focal length of the second lens unit L2 by the focal length of the zoom lens at the telephoto end, and indicates a condition for achieving both a high magnification variation ratio and size reduction. In a case where the value becomes higher than the upper limit of inequality (12) and the refractive power of the second lens unit L2 becomes weak, the moving amount of the second lens unit L2 is increased or the magnification varying effect at the lens units behind the second lens unit L2 is enhanced in order to increase the magnification variation ratio. In a case where the moving amount of the second lens unit L2 is increased, the overall lens length increases. Furthermore, in a case where the magnification varying effect of the lens unit behind the second lens unit L2 is increased, the overall lens length of the entire system becomes longer, and the number of lenses increases. In a case where the refractive power of the second lens unit L2 becomes lower than the lower limit of inequality (12), it is beneficial to the high magnification ratio and the reduced overall lens length, but the Petzval sum becomes negative and the curvature of field increases.

Inequality (13) defines the focal length of the first lens unit L1 by the focal length of the second lens unit L2 to maintain a proper magnification variation ratio and reduce the size of the entire system. In a zoom lens that has a relatively bright telephoto range, unless the refractive power of the first lens unit L1 is properly secured within the aberration correctable range, the overall lens length in the telephoto range increases, and the front lens diameter increases so as to secure the peripheral light amount. In a case where the value becomes higher than the upper limit of inequality (13), the aberration fluctuations of the first lens unit L1 and the second lens unit L2 during zooming increase, and it becomes difficult to suppress curvature of field particularly. In a case where the value becomes lower than the lower limit of inequality (13), the refractive power of the first lens unit L1 increases, which is beneficial to reducing the size of the zoom lens, but it becomes difficult to correct spherical aberration in the telephoto range.

Inequality (14) defines the back focus of the zoom lens at the telephoto end by the focal length of the zoom lens at the telephoto end to properly set the moving amount of the fourth lens unit L4 while reducing the overall lens length. In a case where the value becomes higher than the upper limit of inequality (14), the back focus becomes long and the overall lens length increases. In a case where the value becomes lower than the lower limit of inequality (14), it becomes easy to secure the moving amount of the fourth lens unit L4, but it becomes difficult to correct curvature of field in an in-focus state using the fourth lens unit L4.

Inequalities (4) to (14) may be replaced with inequalities (4a) to (14a) below:

6.1<β2t/β2w<10.0 (4a)

0.5<SF3u<4.5 (5a)

8.6<TDw/fw<16.0 (6a)

1.4<f3A/f3B<8.5 (7a)

2.0<TS3Bt<3.2 (8a)

2.1<f1/f3<4.0 (9a)

1.50<nd3PA<1.65 (10a)

52<νd3PA<80 (11a)

0.03<|f2/ft|<0.10 (12a)

4.7<|f1/f2|<7.5 (13a)

0.02<skt/ft<0.15 (14a)

Inequalities (4) to (14) may be replaced with inequalities (4b) to (14b) below:

6.6<β2t/β2w<7.9 (4b)

0.6<SF3u<3.3 (5b)

9.2<TDw/fw<14.3 (6b)

1.45<f3A/f3B<8.15 (7b)

2.15<TS3Bt<2.80 (8b)

2.4<f1/f3<3.3 (9b)

1.52<nd3PA<1.63 (10b)

56<νd3PA<76 (11b)

0.05<|f2/ft|<0.07 (12b)

5.0<|f1/f2|<6.4 (13b)

0.05<skt/ft<0.11 (14b)

A description will now be given of the configurations that may be satisfied by the zoom lens according to each example.

The first lens unit L1 may consist of four or less lenses. This configuration can reduce the number of lenses in the first lens unit L1, which has a large lens diameter, and reduce the size and weight. In addition, the height of the light beam exiting from the first lens unit L1 can be lowered, and various off-axis aberrations such as coma and curvature of field can be satisfactorily corrected.

The first lens unit L1 may consist of, in order from the object side to the image side, a cemented lens of a negative lens and a positive lens, and two single lenses each having positive refractive power. This configuration can easily and satisfactorily correct lateral chromatic aberration over the entire zoom range, and also satisfactorily correct spherical aberration and longitudinal chromatic aberration in the telephoto range, which are problems associated with a high magnification variation ratio.

The second lens unit L2 may consist of four spherical lenses, and these four spherical lenses may include, in order from the object side, a negative lens, a negative lens, a positive lens, and a negative lens (Examples 1, 2, and 5). The second lens unit L2 consisting of spherical lenses can suppress surface shape errors (so-called asperity and irregular component errors) that tend to occur with aspheric lenses. This configuration can correct both lateral chromatic aberration and curvature of field in the wide-angle range and spherical aberration in the telephoto range, while increasing the refractive power of the second lens unit L2. In a case where a negative lens is disposed closest to the object in the second lens unit L2, a retrofocus type power arrangement can be provided within the second lens unit L2, and curvature of field and coma can be satisfactorily corrected in a wide-angle range.

The second lens unit L2 may consist of four spherical lenses, and these four spherical lenses may consist of, in order from the object side, a negative lens, a negative lens, a negative lens, and a positive lens (Examples 3 and 4). This configuration can achieve a wide angle of view and increase the refractive power of the second lens unit L2, while correcting lateral chromatic aberration and curvature of field in the wide-angle range.

The 3B subunit L3B may consist of one negative lens and two positive lenses. This configuration can suppress on-axis chromatic aberration over the entire zoom range while satisfactorily correcting spherical aberration and coma. The 3B subunit L3B consisting of three elements can increase the degree of freedom in selecting glass materials for the achromatization within the 3B subunit L3B, and achieve both corrections of various aberrations and achromatization within the 3B subunit L3B.

The lens unit disposed closest to the image plane in the zoom lens may be fixed relative to the image plane IP during zooming. This configuration can suppress, dust or the like, which is a problem in a case where the lens is removed like an interchangeable lens, and can easily secure durability.

The lens surface closest to the image plane of the lens unit disposed closest to the image plane in the zoom lens may have a convex shape toward the image side. This configuration can relatively easily secure back focus and suppress collection of unnecessary light (ghost) caused by the image sensor.

The third lens unit L3 may include an aspherical surface. Thereby, the curvature of field at the wide-angle end can be effectively corrected while the size can be reduced.

The zoom lens according to each example may include a protective glass configured to protect the lens and disposed on the object side of the first lens unit L1. A protective glass or a low-pass filter may be placed between the lens placed closest to the image plane and the image plane IP. Optical members each having extremely low refractive power, such as a protective glass and a low-pass filter, disposed closest to the object and closest to the image plane of the zoom lens are not regarded as lenses constituting the zoom lens. The “extremely low refractive power” refers to an optical member whose absolute value of the focal length is five times or more the focal length of a zoom lens.

The aperture stop SP may be placed closest to the object of the third lens unit L3. Thereby, a predetermined angle of view is secured at the wide-angle end, and it is easy to suppress an increase in the front lens diameter in an attempt to achieve a high magnification variation ratio.

The lens element (single lens or cemented lens) disposed adjacent to the image side of the aperture stop SP may have a strongly convex shape toward the object side. The lens surface having a strongly convex shape toward the aperture stop SP can easily suppress spherical aberrations associated with a large aperture diameter and correct various off-axis aberrations in the wide-angle range. The strongly convex element with a cemented lens can easily correct spherical aberration, coma, and curvature of field.

The zoom lens according to each example can provide image stabilization by setting the whole or part of one of the lens units as an image stabilizing unit and by moving the image stabilizing unit to include a component in a direction orthogonal to the optical axis, or by rotating or swinging the image stabilizing unit in an in-plane direction including the optical axis. In particular, the zoom lenses according to Examples 1 to 5 may perform image stabilization by moving the whole or part of the third lens unit L3 so as to include the component in the direction orthogonal to the optical axis. The 3B subunit L3B may be set to the image stabilizing lens unit.

The number of lenses or shapes of lenses in the image stabilizing unit is not limited. The image stabilizing unit may have positive refractive power.

The zoom lens according to each example may provide focusing by moving the whole or part of one of the lens units as a focus unit so as to include a component in the optical axis direction.

The zoom lens according to each example may not include a diffractive optical element. A zoom lens including a diffractive optical element is beneficial to the correction of chromatic aberration, but diffractive flare occurs in the diffractive optical element.

A detailed description will now be given of the zoom lens according to each example.

The zoom lens according to Example 1 consists of a first lens unit L1 having positive refractive power, a second lens unit L2 having negative refractive power, a third lens unit L3 having positive refractive power, a fourth lens unit L4 having negative refractive power, and a fifth lens unit L5 having positive refractive power. The third lens unit L3 has three positive lens elements. The first positive lens element is a cemented lens consisting of a ninth lens and a tenth lens, the second positive lens element is an eleventh lens, and the third positive lens element is a thirteenth lens. Here, the positive lens element refers to a single lens having positive refractive power, a cemented lens having positive combined refractive power after a positive lens and a negative lens are cemented, a replica lens having positive refractive power having an aspherical shape formed by molding an ultraviolet curing resin into an aspherical shape on a single lens having positive refractive power.

In the zoom lens according to Example 1, in the reference state in an in-focus state on an object at infinity, for zooming from the wide-angle end to the telephoto end, the second lens unit L2 monotonically moves toward the image side, and the fourth lens unit L4 moves toward the image side along a convex locus. During focusing on a close object, the fourth lens unit L4 moves toward the image side.

The zoom lens according to Example 2 consists of a first lens unit L1 having positive refractive power, a second lens unit L2 having negative refractive power, a third lens unit L3 having positive refractive power, a fourth lens unit L4 having negative refractive power, a fifth lens unit L5 having positive refractive power, and a sixth lens unit L6 having positive refractive power. The third lens unit L3 has three positive lens elements. The first positive lens element is a cemented lens consisting of a ninth lens and a tenth lens, the second positive lens element is an eleventh lens, and the third positive lens element is a thirteenth lens.

In the zoom lens according to Example 2, in the reference state in an in-focus state on an object at infinity, for zooming from the wide-angle end to the telephoto end, the second lens unit L2 monotonically moves toward the image side, the fourth lens unit L4 moves toward the image side along a convex locus, and the fifth lens unit L5 monotonically moves toward the image side. During focusing on a close object, the fourth lens unit L4 moves toward the image side.

The zoom lens according to Example 3 consists of a first lens unit L1 having positive refractive power, a second lens unit L2 having negative refractive power, a third lens unit L3 having positive refractive power, a fourth lens unit L4 having negative refractive power, a fifth lens unit L5 having positive refractive power, and a sixth lens unit L6 having negative refractive power. The third lens unit L3 has three positive lens elements. The first positive lens element is a cemented lens consisting of a ninth lens and a tenth lens, the second positive lens element is an eleventh lens, and the third positive lens element is a thirteenth lens.

In the zoom lens according to Example 3, in the reference state in an in-focus state on an object at infinity, for zooming from the wide-angle end to the telephoto end, the second lens unit L2 moves monotonically toward the image side, the fourth lens unit L4 moves toward the image side along a convex locus, and the fifth lens unit L5 monotonically moves toward the image side. During focusing on a close object, the fourth lens unit L4 moves toward the image side.

The zoom lens according to Example 4 consists of a first lens unit L1 having positive refractive power, a second lens unit L2 having negative refractive power, a third lens unit L3 having positive refractive power, a fourth lens unit L4 having negative refractive power, a fifth lens unit L5 having positive refractive power, and a sixth lens unit L6 having negative refractive power. The third lens unit L3 has three positive lens elements. The first positive lens element is the ninth lens, the second positive lens element is the twelfth lens, and the third positive lens element is the fourteenth lens.

In the zoom lens according to Example 4, in the reference state in an in-focus state on an object at infinity, for zooming from the wide-angle end to the telephoto end, the second lens unit L2 monotonically moves toward the image side, the fourth lens unit L4 moves toward the image side along a convex locus, and the fifth lens unit L5 monotonically moves toward the image side. During focusing on a close object, the fourth lens unit L4 moves toward the image side.

The zoom lens according to Example 5 consists of a first lens unit L1 having positive refractive power, a second lens unit L2 having negative refractive power, a third lens unit L3 having positive refractive power, a fourth lens unit L4 having negative refractive power, and a fifth lens unit L5 having positive refractive power. The third lens unit L3 has three positive lens elements. The first positive lens element is a cemented lens consisting of a ninth lens and a tenth lens, the second positive lens element is a cemented lens consisting of an eleventh lens and a twelfth lens, and the third positive lens element is a cemented lens consisting of a thirteenth lens.

In the zoom lens according to Example 5, in the reference state in an in-focus state on an object at infinity, for zooming from the wide-angle end to the telephoto end, the second lens unit L2 monotonically moves toward the image side, and the fourth lens unit L4 moves toward the image side along a convex locus. During focusing on a close object, the fourth lens unit L4 moves toward the image side.

A description will now be given of numerical examples 1 to 5 corresponding to Examples 1 to 5, respectively.

In the surface data of each numerical example, r represents a radius of curvature of each optical surface, and d (mm) represents an on-axis distance (distance on the optical axis) between m-th and (m+1)-th surfaces, where m is the number of the surface counted from the light incident side. nd represents a refractive index of each optical member for the d-line, νd represents an Abbe number of the optical member based on the d-line, and θgF represents a partial dispersion ratio θgF of the optical member. The Abbe number νd and the partial dispersion ratio θgF is expressed as follows:

νd=(Nd−1)/(NF−NC)

θgF=(Ng−NF)/(NF−NC)

where Nd, NF, NC, and Ng are refractive indices for the d-line (587.6 nm), the F-line (486.1 nm), the C-line (656.3 nm), and the g-line in the Fraunhofer line.

In each numerical example, d, focal length (mm), F number, and half angle of view (°) are all values in a case where the zoom lens according to each example focuses on an object at infinity. The back focus BF is a distance on the optical axis from the final lens surface (lens surface closest to the image plane) of the zoom lens to the paraxial image surface expressed in terms of air equivalent length. An overall lens length is a length obtained by adding the back focus to the distance on the optical axis from the foremost lens surface (lens surface closest to the object) to the final lens surface. The lens unit includes one or more lenses.

An asterisk “*” attached to a surface number means that the surface has an aspherical shape. The aspherical shape is expressed as follows:

x=(h²/R)/[1+{1−(1+k)(h/R)²}^{1/2}]+A4×h⁴+A6×h⁶+A8×h⁸+A10×h¹⁰+A12×h¹²

where x is a displacement amount from the surface vertex in the optical axis direction, h is a height from the optical axis in the direction perpendicular to the optical axis, R is a paraxial radius of curvature, k is a conical constant, and A4, A6, A8, A10, and A12 are aspherical coefficients of each order. “e±XX” in each aspherical coefficient means “×10^{±XX}.” WIDE represents the wide-angle end, MIDDLE represents an intermediate (middle) zoom position, TELE represents a telephoto end.

### Numerical Example 1

UNIT: mm

SURFACE DATA

| Surface No. | r | d | nd | νd | θgF |
|---|---|---|---|---|---|
| 1 | 163.564 | 1.98 | 1.91650 | 31.60 | 0.5911 |
| 2 | 64.691 | 6.47 | 1.49700 | 81.54 | 0.5375 |
| 3 | −742.875 | 0.20 | | | |
| 4 | 66.915 | 5.43 | 1.49700 | 81.54 | 0.5375 |
| 5 | 1380.721 | 0.20 | | | |
| 6 | 54.119 | 4.86 | 1.59522 | 67.74 | 0.5442 |
| 7 | 197.294 | (Variable) | | | |
| 8 | 311.747 | 1.10 | 2.00100 | 29.13 | 0.5997 |
| 9 | 15.893 | 3.86 | | | |
| 10 | −35.852 | 0.95 | 1.61800 | 63.40 | 0.5395 |
| 11 | 18.455 | 4.19 | 1.94594 | 17.98 | 0.6546 |
| 12 | −184.118 | 1.25 | | | |
| 13 | −26.311 | 0.90 | 1.95375 | 32.32 | 0.5898 |
| 14 | −94.723 | (Variable) | | | |
| 15 (SP) | ∞ | 1.55 | | | |
| 16 | 27.816 | 1.10 | 1.83481 | 42.74 | 0.5648 |
| 17 | 16.708 | 3.52 | 1.51633 | 64.14 | 0.5353 |
| 18 | −402.356 | 1.47 | | | |
| 19 | 14.397 | 4.71 | 1.49700 | 81.54 | 0.5375 |
| 20 | −418.033 | 0.66 | | | |
| 21 | 35.241 | 1.10 | 2.00100 | 29.14 | 0.5997 |
| 22 | 16.105 | 0.72 | | | |
| 23* | 22.567 | 3.26 | 1.58313 | 59.38 | 0.5423 |
| 24* | −51.514 | (Variable) | | | |
| 25 | 780.860 | 0.70 | 1.95375 | 32.32 | 0.5898 |
| 26 | 11.596 | 1.84 | 1.92119 | 23.96 | 0.6203 |
| 27 | 35.185 | 1.57 | | | |
| 28 | −84.051 | 2.19 | 1.85883 | 30.00 | 0.5980 |
| 29 | −11.542 | 0.70 | 1.80450 | 39.64 | 0.5717 |
| 30 | 103.108 | (Variable) | | | |
| 31 | 53.512 | 3.43 | 1.49700 | 81.54 | 0.5375 |
| 32 | −43.502 | 0.20 | | | |
| 33 | 33.431 | 3.32 | 1.51823 | 58.90 | 0.5457 |
| 34 | −108.313 | 0.94 | | | |
| 35 | −39.933 | 1.10 | 1.83400 | 37.34 | 0.5790 |
| 36 | 37.101 | 3.32 | 1.49700 | 81.54 | 0.5375 |
| 37 | −73.579 | 20.15 | | | |
| Image Plane | ∞ | | | | |

### Aspheric Data

### 23rd Surface

K=0.00000e+000 A 4=−5.69434e−005 A 6=−5.67972e−007

### 24th Surface

K=0.00000e+000 A 4=−5.86463e−006 A 6=−4.55933e−007 A 8=5.23116e−009 A10=−6.92318e−011 A12=6.71428e−013

VARIOUS DATA
ZOOM RATIO 13.48

| | WIDE | MIDDLE | TELE |
|---|---|---|---|
| Focal Length | 14.79 | 70.44 | 199.38 |
| FNO | 4.10 | 5.08 | 5.06 |
| Half Angle of View (°) | 30.81 | 7.00 | 2.48 |
| Image Height | 8.20 | 8.90 | 8.90 |
| Overall Lens Length | 156.89 | 156.89 | 156.89 |
| BF | 20.15 | 20.15 | 20.15 |
| d 7 | 1.09 | 29.64 | 41.87 |
| d14 | 42.33 | 13.78 | 1.55 |
| d24 | 1.38 | 11.74 | 11.48 |
| d30 | 23.15 | 12.79 | 13.05 |

ZOOM LENS UNIT DATA

| Lens Unit | Starting Surface | Focal Length |
|---|---|---|
| 1 | 1 | 67.61 |
| 2 | 8 | −11.26 |
| 3 | 15 | 20.91 |
| 4 | 25 | −23.84 |
| 5 | 31 | 50.67 |

### Numerical Example 2

UNIT: mm

SURFACE DATA

| Surface No. | r | d | nd | νd | θgF |
|---|---|---|---|---|---|
| 1 | 170.848 | 1.98 | 1.91650 | 31.60 | 0.5911 |
| 2 | 65.664 | 6.36 | 1.49700 | 81.61 | 0.5386 |
| 3 | −698.386 | 0.20 | | | |
| 4 | 67.680 | 5.50 | 1.49700 | 81.61 | 0.5386 |
| 5 | 2906.264 | 0.20 | | | |
| 6 | 52.496 | 4.93 | 1.59282 | 68.62 | 0.5458 |
| 7 | 184.287 | (Variable) | | | |
| 8 | 340.308 | 1.10 | 2.00100 | 29.13 | 0.5997 |
| 9 | 15.471 | 3.86 | | | |
| 10 | −33.058 | 0.95 | 1.59349 | 67.00 | 0.5361 |
| 11 | 18.430 | 4.14 | 1.94594 | 17.98 | 0.6546 |
| 12 | −170.431 | 1.14 | | | |
| 13 | −26.840 | 0.90 | 1.95375 | 32.32 | 0.5898 |
| 14 | −108.820 | (Variable) | | | |
| 15 (SP) | ∞ | 1.55 | | | |
| 16 | 27.612 | 1.10 | 1.81600 | 46.62 | 0.5568 |
| 17 | 16.960 | 4.79 | 1.48749 | 70.23 | 0.5300 |
| 18 | −137.657 | 4.51 | | | |
| 19 | 16.428 | 3.95 | 1.52841 | 76.46 | 0.5396 |
| 20 | 11285.050 | 0.63 | | | |
| 21 | 32.032 | 1.10 | 2.05090 | 26.94 | 0.6054 |
| 22 | 17.146 | 0.77 | | | |
| 23* | 29.010 | 3.04 | 1.58313 | 59.38 | 0.5423 |
| 24* | −53.783 | (Variable) | | | |
| 25 | 339.553 | 0.70 | 2.00100 | 29.13 | 0.5997 |
| 26 | 18.123 | 1.51 | 1.72825 | 28.46 | 0.6077 |
| 27 | 52.840 | 1.42 | | | |
| 28 | −93.141 | 0.70 | 1.72916 | 54.68 | 0.5444 |
| 29 | 14.833 | 2.08 | 1.85451 | 25.16 | 0.6102 |
| 30 | 83.776 | (Variable) | | | |
| 31 | 98.612 | 2.74 | 1.53775 | 74.70 | 0.5392 |
| 32 | −50.291 | (Variable) | | | |
| 33 | 30.921 | 3.58 | 1.60342 | 38.03 | 0.5835 |
| 34 | −87.430 | 0.85 | | | |
| 35 | −39.231 | 1.10 | 1.95375 | 32.32 | 0.5898 |
| 36 | 31.331 | 4.03 | 1.52841 | 76.46 | 0.5396 |
| 37 | −47.250 | 20.52 | | | |
| Image Plane | ∞ | | | | |

### Aspheric Data

### 23rd Surface

K=0.00000e+000 A 4=−4.59719e−005 A 6=−3.39844e−007

### 24th Surface

K=0.00000e+000 A 4=−1.58113e−005 A 6=−3.07059e−007 A 8=4.11220e−009 A10=−7.71708e−011 A12=6.75009e−013

VARIOUS DATA
ZOOM RATIO 13.50

| | WIDE | MIDDLE | TELE |
|---|---|---|---|
| Focal Length | 14.78 | 69.57 | 199.63 |
| FNO | 4.10 | 5.30 | 5.29 |
| Half Angle of View (°) | 30.66 | 7.06 | 2.47 |
| Image Height | 8.20 | 8.90 | 8.90 |
| Overall Lens Length | 164.45 | 164.45 | 164.45 |
| BF | 20.52 | 20.52 | 20.52 |
| d 7 | 1.13 | 29.52 | 41.68 |
| d14 | 42.27 | 13.88 | 1.71 |
| d24 | 1.33 | 13.59 | 13.73 |
| d30 | 22.75 | 13.15 | 14.40 |
| d32 | 5.04 | 2.39 | 0.99 |

ZOOM LENS UNIT DATA

| Lens Unit | Starting Surface | Focal Length |
|---|---|---|
| 1 | 1 | 67.06 |
| 2 | 8 | −11.06 |
| 3 | 15 | 22.76 |
| 4 | 25 | −27.52 |
| 5 | 31 | 62.34 |
| 6 | 33 | 691.29 |

### Numerical Example 3

UNIT: mm

SURFACE DATA

| Surface No. | r | d | nd | νd | θgF |
|---|---|---|---|---|---|
| 1 | 230.242 | 1.60 | 1.91650 | 31.60 | 0.5911 |
| 2 | 58.858 | 8.33 | 1.49700 | 81.54 | 0.5375 |
| 3 | −758.604 | 0.20 | | | |
| 4 | 65.214 | 6.71 | 1.49700 | 81.54 | 0.5375 |
| 5 | −959.320 | 0.20 | | | |
| 6 | 56.881 | 4.36 | 1.76385 | 48.49 | 0.5589 |
| 7 | 180.827 | (Variable) | | | |
| 8 | 213.157 | 0.80 | 1.83481 | 42.74 | 0.5648 |
| 9 | 20.543 | 3.62 | | | |
| 10 | −64.572 | 0.70 | 1.75500 | 52.32 | 0.5474 |
| 11 | 20.167 | 3.74 | | | |
| 12 | −27.921 | 0.70 | 1.49700 | 81.54 | 0.5375 |
| 13 | 92.672 | 0.20 | | | |
| 14 | 40.616 | 2.42 | 1.94594 | 17.98 | 0.6546 |
| 15 | −376.643 | (Variable) | | | |
| 16 (SP) | ∞ | 1.40 | | | |
| 17 | 34.737 | 1.20 | 1.69680 | 55.53 | 0.5434 |
| 18 | 17.878 | 3.66 | 1.51633 | 64.14 | 0.5353 |
| 19 | −381.262 | 1.44 | | | |
| 20 | 16.066 | 4.65 | 1.49700 | 81.54 | 0.5375 |
| 21 | −256.903 | 0.46 | | | |
| 22 | 41.774 | 0.90 | 2.00100 | 29.13 | 0.5997 |
| 23 | 16.356 | 0.29 | | | |
| 24* | 18.445 | 3.41 | 1.58313 | 59.38 | 0.5423 |
| 25* | −60.222 | (Variable) | | | |
| 26 | −152.868 | 0.80 | 1.95375 | 32.32 | 0.5898 |
| 27 | 12.534 | 2.52 | 1.85896 | 22.73 | 0.6284 |
| 28 | 42.496 | 0.50 | | | |
| 29 | 22706.322 | 1.95 | 1.75211 | 25.05 | 0.6190 |
| 30 | −23.566 | 0.80 | 1.83481 | 42.74 | 0.5648 |
| 31 | 102.002 | (Variable) | | | |
| 32 | 49.625 | 3.71 | 1.54072 | 47.23 | 0.5651 |
| 33 | −37.462 | 0.20 | | | |
| 34 | 29.016 | 1.20 | 2.00100 | 29.13 | 0.5997 |
| 35 | 15.481 | 5.59 | 1.55200 | 70.70 | 0.5421 |
| 36 | −68.401 | (Variable) | | | |
| 37 | −26.441 | 1.00 | 1.85451 | 25.16 | 0.6102 |
| 38 | −125.365 | 2.21 | 1.51742 | 52.43 | 0.5564 |
| 39 | −29.591 | 10.67 | | | |
| Image Plane | ∞ | | | | |

### Aspheric Data

### 24th Surface

K=−3.61407e+000 A 4=4.58665e−005 A 6=−7.46405e−008 A 8=−4.30149e−009 A10=4.29935e−011

### 25th Surface

K=−1.18700e+000 A 4=9.04042e−006 A 6=2.20439e−007 A 8=−6.10662e−009 A10=6.32565e−011

VARIOUS DATA
ZOOM RATIO 17.21

| | WIDE | MIDDLE | TELE |
|---|---|---|---|
| Focal Length | 10.33 | 57.96 | 177.78 |
| FNO | 2.83 | 4.28 | 4.46 |
| Half Angle of View (°) | 36.49 | 7.02 | 2.30 |
| Image Height | 7.00 | 7.41 | 7.41 |
| Overall Lens Length | 157.77 | 157.77 | 157.77 |
| BF | 10.67 | 10.67 | 10.67 |
| d 7 | 0.99 | 30.17 | 42.68 |
| d15 | 43.02 | 13.84 | 1.33 |
| d25 | 1.70 | 15.31 | 15.79 |
| d31 | 17.84 | 9.66 | 13.28 |
| d36 | 12.10 | 6.67 | 2.57 |

ZOOM LENS UNIT DATA

| Lens Unit | Starting Surface | Focal Length |
|---|---|---|
| 1 | 1 | 66.24 |
| 2 | 8 | −11.51 |
| 3 | 16 | 22.20 |
| 4 | 26 | −21.21 |
| 5 | 32 | 26.37 |
| 6 | 37 | −90.60 |

### Numerical Example 4

UNIT: mm

SURFACE DATA

| Surface No. | r | d | nd | νd | θgF |
|---|---|---|---|---|---|
| 1 | 411.592 | 1.60 | 1.91650 | 31.60 | 0.5911 |
| 2 | 60.958 | 6.78 | 1.49700 | 81.61 | 0.5386 |
| 3 | −229.195 | 0.20 | | | |
| 4 | 63.960 | 4.97 | 1.52841 | 76.46 | 0.5396 |
| 5 | −41540.097 | 0.20 | | | |
| 6 | 57.829 | 4.05 | 1.76385 | 48.49 | 0.5589 |
| 7 | 224.306 | (Variable) | | | |
| 8 | 203.195 | 0.80 | 1.83481 | 42.74 | 0.5648 |
| 9 | 23.897 | 2.66 | | | |
| 10 | −71.551 | 0.70 | 1.75500 | 52.32 | 0.5474 |
| 11 | 19.545 | 3.75 | | | |
| 12 | −22.637 | 0.70 | 1.49700 | 81.54 | 0.5375 |
| 13 | 201.392 | 0.20 | | | |
| 14 | 47.791 | 2.15 | 1.94594 | 17.98 | 0.6546 |
| 15 | −173.122 | (Variable) | | | |
| 16 (SP) | ∞ | 1.40 | | | |
| 17 | 25.067 | 3.12 | 1.59349 | 67.00 | 0.5361 |
| 18 | −233.040 | 0.20 | | | |
| 19 | 55.336 | 3.80 | 1.60342 | 38.03 | 0.5835 |
| 20 | −23.179 | 1.10 | 1.83481 | 42.74 | 0.5648 |
| 21 | 31.030 | 3.10 | | | |
| 22 | 19.094 | 4.71 | 1.59282 | 68.62 | 0.5458 |
| 23 | −40.780 | 0.13 | | | |
| 24 | −113.304 | 0.90 | 1.90366 | 31.32 | 0.5946 |
| 25 | 24.810 | 0.27 | | | |
| 26* | 26.317 | 3.33 | 1.69350 | 53.20 | 0.5468 |
| 27* | −42.993 | (Variable) | | | |
| 28 | −708.086 | 0.80 | 2.00100 | 29.13 | 0.5997 |
| 29 | 23.011 | 0.20 | | | |
| 30 | 20.997 | 3.79 | 1.77830 | 23.91 | 0.6248 |
| 31 | −25.772 | 0.80 | 1.83481 | 42.74 | 0.5648 |
| 32 | 29.717 | (Variable) | | | |
| 33 | 57.664 | 3.45 | 1.49700 | 81.61 | 0.5386 |
| 34 | −53.093 | 0.20 | | | |
| 35 | 27.113 | 1.20 | 2.00100 | 29.13 | 0.5997 |
| 36 | 18.686 | 5.25 | 1.53775 | 74.70 | 0.5392 |
| 37 | 106.427 | (Variable) | | | |
| 38 | −34.530 | 0.80 | 1.85883 | 30.00 | 0.5980 |
| 39 | 2461.473 | 2.18 | 1.51742 | 52.43 | 0.5564 |
| 40 | −39.078 | 10.90 | | | |
| Image Plane | ∞ | | | | |

### Aspheric Data

### 26th Surface

K=−5.02865e+000 A 4=−2.46915e−006 A 6=−1.16027e−008 A 8=−2.36011e−009 A10=1.93859e−011

### 27th Surface

K=−6.72945e+000 A 4=−9.33779e−006 A 6=1.51538e−007 A 8=−2.95596e−009 A10=2.58890e−011

VARIOUS DATA
ZOOM RATIO 14.78

| | WIDE | MIDDLE | TELE |
|---|---|---|---|
| Focal Length | 12.04 | 65.62 | 177.90 |
| FNO | 2.83 | 4.43 | 4.52 |
| Half Angle of View (°) | 30.39 | 6.29 | 2.31 |
| Image Height | 6.45 | 7.41 | 7.41 |
| Overall Lens Length | 157.75 | 157.75 | 157.75 |
| BF | 10.90 | 10.90 | 10.90 |
| d 7 | 0.95 | 28.21 | 39.88 |
| d15 | 40.10 | 12.84 | 1.16 |
| d27 | 1.78 | 21.29 | 17.39 |
| d32 | 19.90 | 9.97 | 16.70 |
| d37 | 14.63 | 5.05 | 2.22 |

ZOOM LENS UNIT DATA

| Lens Unit | Starting Surface | Focal Length |
|---|---|---|
| 1 | 1 | 62.70 |
| 2 | 8 | −12.35 |
| 3 | 16 | 25.60 |
| 4 | 28 | −25.84 |
| 5 | 33 | 28.83 |
| 6 | 38 | −89.65 |

### Numerical Example 5

UNIT: mm

SURFACE DATA

| Surface No. | r | d | nd | νd | θgF |
|---|---|---|---|---|---|
| 1 | 141.695 | 1.80 | 1.90110 | 27.06 | 0.6072 |
| 2 | 69.419 | 5.39 | 1.49700 | 81.61 | 0.5386 |
| 3 | −524.188 | 0.20 | | | |
| 4 | 66.617 | 3.78 | 1.49700 | 81.61 | 0.5386 |
| 5 | 346.098 | 0.20 | | | |
| 6 | 50.720 | 4.15 | 1.55032 | 75.50 | 0.5405 |
| 7 | 204.235 | (Variable) | | | |
| 8 | −16120.476 | 1.00 | 2.00100 | 29.13 | 0.5997 |
| 9 | 19.421 | 2.59 | | | |
| 10 | −63.297 | 0.90 | 1.75500 | 52.32 | 0.5474 |
| 11 | 16.251 | 3.69 | 1.94594 | 17.98 | 0.6546 |
| 12 | 1164.661 | 1.35 | | | |
| 13 | −23.631 | 0.80 | 1.80420 | 46.50 | 0.5572 |
| 14 | 6973.856 | (Variable) | | | |
| 15 (SP) | ∞ | 1.40 | | | |
| 16 | 25.490 | 0.90 | 1.75500 | 52.32 | 0.5475 |
| 17 | 13.358 | 4.08 | 1.55032 | 75.50 | 0.5405 |
| 18 | −66.975 | 4.56 | | | |
| 19 | 117.808 | 0.90 | 1.92119 | 23.96 | 0.6203 |
| 20 | 33.672 | 2.41 | 1.45860 | 90.19 | 0.5354 |
| 21 | −78.282 | 0.30 | | | |
| 22* | 32.690 | 3.28 | 1.58313 | 59.46 | 0.5418 |
| 23* | −37.970 | (Variable) | | | |
| 24 | −62.291 | 0.80 | 1.95375 | 32.32 | 0.5898 |
| 25 | 25.247 | 3.13 | 1.85478 | 24.80 | 0.6122 |
| 26 | −20.607 | 0.80 | 1.61340 | 44.27 | 0.5633 |
| 27 | 55.827 | 0.72 | | | |
| 28 | −53.969 | 0.70 | 1.83481 | 42.72 | 0.5650 |
| 29 | 230.500 | (Variable) | | | |
| 30 | 218.012 | 2.84 | 1.55032 | 75.50 | 0.5405 |
| 31 | −33.269 | 0.20 | | | |
| 32 | 84.665 | 3.36 | 1.49700 | 81.61 | 0.5386 |
| 33 | −42.363 | 0.20 | | | |
| 34 | 45.890 | 4.32 | 1.49700 | 81.61 | 0.5386 |
| 35 | −22.196 | 1.20 | 2.00100 | 29.13 | 0.5997 |
| 36 | 362.053 | 2.54 | | | |
| 37 | −35.687 | 1.00 | 1.80420 | 46.50 | 0.5572 |
| 38 | 27.633 | 4.01 | 1.73037 | 32.23 | 0.5900 |
| 39 | −36.554 | 17.35 | | | |
| Image Plane | ∞ | | | | |

### Aspheric Data

### 22nd Surface

K=−2.66921e+001 A 4=7.92692e−005 A 6=−1.07008e−006 A 8=1.07672e−008 A10=−6.35981e−011

### 23rd Surface

K=4.45661e+000 A 4=6.51155e−006 A 6=−2.62520e−008 A 8=−3.24200e−010

VARIOUS DATA
ZOOM RATIO 13.96

| | WIDE | MIDDLE | TELE |
|---|---|---|---|
| Focal Length | 12.88 | 72.61 | 179.77 |
| FNO | 4.00 | 5.34 | 5.37 |
| Half Angle of View (0) | 30.69 | 6.00 | 2.42 |
| Image Height | 7.00 | 7.90 | 7.90 |
| Overall Lens Length | 155.89 | 155.89 | 155.89 |
| BF | 17.35 | 17.35 | 17.35 |
| d 7 | 1.30 | 30.03 | 39.61 |
| d14 | 40.11 | 11.37 | 1.79 |
| d23 | 1.84 | 14.26 | 14.65 |
| d29 | 25.79 | 13.37 | 12.98 |

ZOOM LENS UNIT DATA

| Lens Unit | Starting Surface | Focal Length |
|---|---|---|
| 1 | 1 | 64.34 |
| 2 | 8 | −10.20 |
| 3 | 15 | 21.07 |
| 4 | 24 | −25.81 |
| 5 | 30 | 46.66 |

Table I summarizes various values of inequalities in each example.

TABLE 1

| | Ex. 1 | Ex. 2 | Ex. 3 | Ex. 4 | Ex. 5 |
|---|---|---|---|---|---|
| fw | 14.788 | 14.784 | 10.333 | 12.040 | 12.880 |
| ft | 199.384 | 199.634 | 177.776 | 177.900 | 179.771 |
| f1 | 67.608 | 67.058 | 66.244 | 62.703 | 64.344 |
| f2 | −11.256 | −11.065 | −11.506 | −12.349 | −10.200 |
| f3 | 20.912 | 22.758 | 22.198 | 25.598 | 21.075 |
| f4 | −23.842 | −27.521 | −21.206 | −25.844 | −25.813 |
| f5 | 50.675 | 62.335 | 26.374 | 28.830 | 46.661 |
| f6 | | 691.288 | −90.596 | −89.651 | |
| TDw | 136.732 | 143.925 | 147.103 | 146.851 | 138.540 |
| TDt | 136.732 | 143.925 | 147.103 | 146.851 | 138.540 |
| skw | 20.155 | 20.525 | 10.672 | 10.901 | 17.349 |
| skt | 20.155 | 20.525 | 10.672 | 10.901 | 17.349 |
| LD | 156.887 | 164.450 | 157.775 | 157.752 | 155.890 |
| β2w | −0.238 | −0.235 | −0.241 | −0.276 | −0.227 |
| β3w | −0.442 | −0.474 | −0.452 | −0.548 | −0.469 |
| β4w | 4.994 | 4.989 | −37.039 | −28.420 | 5.879 |
| β5w | 0.417 | 0.428 | −0.033 | −0.038 | 0.320 |
| β6w | | 0.927 | 1.178 | 1.168 | |
| β2t | −1.712 | −1.707 | −1.884 | −2.136 | −1.534 |
| β3t | −0.904 | −0.958 | −0.842 | −0.832 | −1.058 |
| β4t | 4.571 | 3.987 | 4.369 | 3.483 | 5.383 |
| β5t | 0.417 | 0.493 | 0.329 | 0.392 | 0.320 |
| β6t | | 0.927 | 1.178 | 1.168 | |
| β3Bt | −0.465 | −0.438 | −0.423 | −0.753 | −0.262 |
| f3A | 79.871 | 72.005 | 87.641 | 196.236 | 44.828 |
| f3B | 26.008 | 28.915 | 27.647 | 24.116 | 30.443 |
| f3P1 | 79.871 | 72.005 | 87.641 | 38.307 | 44.828 |
| f3P2 | 28.106 | 31.132 | 30.597 | 22.600 | 39831.573 |
| f3P3 | 27.355 | 32.761 | 24.608 | 24.011 | 30.649 |
| nd31 | 1.83481 | 1.81600 | 1.69680 | 1.59349 | 1.75500 |
| nd32 | 1.51633 | 1.48749 | 1.51633 | 1.60342 | 1.55032 |
| nd33 | 1.49700 | 1.52841 | 1.49700 | 1.83481 | 1.92119 |
| nd34 | 2.00100 | 2.05090 | 2.00100 | 1.59282 | 1.45860 |
| nd35 | 1.58313 | 1.58313 | 1.58313 | 1.90366 | 1.58313 |
| nd36 | | | | 1.69350 | |
| vd31 | 42.740 | 46.620 | 55.530 | 67.000 | 52.322 |
| vd32 | 64.140 | 70.230 | 64.140 | 38.030 | 75.500 |
| vd33 | 81.540 | 76.460 | 81.540 | 42.740 | 23.956 |
| vd34 | 29.140 | 26.943 | 29.134 | 68.621 | 90.187 |
| vd35 | 59.380 | 59.380 | 59.380 | 31.315 | 59.461 |
| vd36 | | | | 53.203 | |
| (1)f3/fT | 0.105 | 0.114 | 0.125 | 0.144 | 0.117 |
| (2)nd3u | 2.00100 | 2.05090 | 2.00100 | 1.90366 | 1.92119 |
| (3)β2w | −0.238 | −0.235 | −0.241 | −0.276 | −0.227 |
| (4)β2t/β2w | 7.202 | 7.257 | 7.825 | 7.734 | 6.762 |
| (5)SF3u | 2.683 | 3.303 | 2.287 | 0.641 | 1.800 |
| (6)TDw/fw | 9.246 | 9.735 | 14.237 | 12.197 | 10.756 |
| (7)f3A/f3B | 3.071 | 2.490 | 3.170 | 8.137 | 1.473 |
| (8)TS3Bt | 2.792 | 2.618 | 2.407 | 2.798 | 2.173 |
| (9)f1/f3 | 3.233 | 2.947 | 2.984 | 2.450 | 3.053 |
| (10)nd3PA | 1.532 | 1.533 | 1.532 | 1.621 | 1.531 |
| (11)vd3PA | 68.353 | 68.690 | 68.353 | 56.714 | 75.049 |
| (12)\|f2\|/ft | 0.056 | 0.055 | 0.065 | 0.069 | 0.057 |
| (13)f1/\|f2\| | 6.006 | 6.060 | 5.757 | 5.078 | 6.308 |
| (14)skt/ft | 0.101 | 0.103 | 0.060 | 0.061 | 0.097 |

### Image Pickup Apparatus

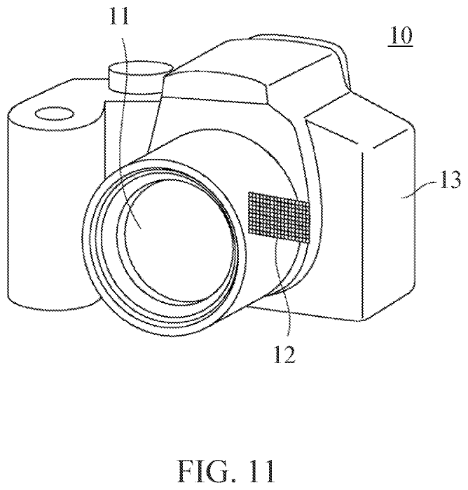

Referring now to FIG. 11, a description will be given of an example of a digital still camera (image pickup apparatus) 10 using the zoom lens according to each example for an imaging optical system. FIG. 11 illustrates the configuration of the image pickup apparatus 10. The image pickup apparatus 10 includes a camera body 13, a lens apparatus 11 including the zoom lens of any one of Examples 1 to 5, and an image sensor (light receiving element) 12 that photoelectrically converts an image formed by the zoom lens. The image sensor 12 can use an image sensor such as a CCD sensor and a CMOS sensor. The lens apparatus 11 and the camera body 13 may be integrated or detachable. The camera body 13 may be a so-called single-lens reflex camera with a quick turn mirror, or a so-called mirrorless camera without a quick turn mirror.

Thus, applying the zoom lens according to each example to the image pickup apparatus 10 such as a digital still camera can provide the image pickup apparatus 10 with a reduced size, a reduced weight, and high optical performance.

The image pickup apparatus 10 according to this example is not limited to the digital still camera illustrated in FIG. 11, but each example is applicable to various image pickup apparatuses such as a broadcasting camera, a film-based camera, and a surveillance camera.

### Image Pickup System

An image pickup system (surveillance camera system) may include the zoom lens according each example and a control unit configured to control the zoom lens. In this case, the control unit can control the zoom lens so that each lens unit moves as described above during zooming, focusing, and image stabilization. The control unit does not have to be integrated with the zoom lens but may be separate from the zoom lens. For example, the control unit (control apparatus) may be remotely disposed from a driving unit that drives each lens unit of the zoom lens, and may include a transmission unit that transmits a control signal (command) for controlling the zoom lens. This control unit can remotely control the zoom lens.

Moreover, an operation unit for remotely operating the zoom lens, such as a controller or a button may be provided to the control unit and the zoom lens may be controlled in accordance with an input to the operation unit from a user. For example, a scale-up button and a scale-down button may be provided as the operation unit. In this case, a signal may be transmitted from the control unit to the driving unit of the zoom lens so that the magnification of the zoom lens increases in a case where the scale-up button is pressed by the user and the magnification of the zoom lens decreases in a case where the scale-down button is pressed by the user.

The image pickup system may include a display unit such as a liquid crystal panel that displays information (moving state) on zoom of the zoom lens. The information on zoom of the zoom lens is, for example, zoom magnification (zoom state) and the moving amount (moving state) of each lens unit. In this case, the user can remotely operate the zoom lens through the operation unit while viewing the information on zoom of the zoom lens and displayed on the display unit. The display unit and the operation unit may be integrated using a touch panel or the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide a zoom lens having a small size and a high magnification variation ratio, in which various aberrations such as chromatic aberration and spherical aberration are satisfactorily corrected over the entire zoom range.

This application claims priority to Japanese Patent Application No. 2023-060157, which was filed on Apr. 3, 2023, and which is hereby incorporated by reference herein in its entirety.

What is claimed is:

1. A zoom lens comprising four or more lenses that include, in order from an object side to an image side, a first lens unit having positive refractive power, a second lens unit having negative refractive power, and a third lens unit having positive refractive power,
wherein a distance between adjacent lens units changes during zooming from a wide-angle end to a telephoto end,
wherein for zooming from the wide-angle end to the telephoto end, the first lens unit and the third lens unit are fixed relative to an image plane, and the second lens unit moves toward the image side,
wherein the third lens unit includes three lens elements each having positive refractive power, and
wherein the following inequalities are satisfied:
0.005<f3/ft<0.150
1.902<nd3u<2.300
−0.50<β2w<−0.01
where f3 is a focal length of the third lens unit, ft is a focal length of the zoom lens at the telephoto end, nd3u is a maximum value among refractive indices for d-line of lenses included in the third lens unit, and β2w is a lateral magnification of the second lens at the wide-angle end.

2. The zoom lens according to claim 1, wherein the following inequality is satisfied:
5.5<β2t/β2w<12.0
where β2t is a lateral magnification of the second lens unit at the telephoto end.

3. The zoom lens according to claim 1, wherein the following inequality is satisfied:
0.4<SF3u<8.0
where SF3u is a shape factor of a lens having a maximum refractive index for the d-line among the lenses included in the third lens unit.

4. The zoom lens according to claim 1, wherein the following inequality is satisfied:
8.0<TDw/fw<19.0
where TDw is an overall lens length of the zoom lens at the wide-angle end, and fw is a focal length of the zoom lens at the wide-angle end.

5. The zoom lens according to claim 1, wherein the third lens unit consists of, in order from the object side to the image side, a first subunit and a second subunit that are spaced by a largest air gap, and
wherein the following inequality is satisfied:
1.2<f3A/f3B<9.0
where f3A is a focal length of the first subunit, and f3B is a focal length of the second subunit.

6. The zoom lens according to claim 1, wherein the third lens unit consists of, in order from the object side to the image side, a first subunit and a second subunit that are spaced by a largest air gap, and
wherein the following inequality is satisfied:
1.7<β3t×(1−βRt)<4.0
where β3t is a lateral magnification of the second subunit at the telephoto end, and βRt is a combined lateral magnification of lenses on the image side of the second subunit.

7. The zoom lens according to claim 1, wherein the following inequality is satisfied:
1.8<f1/f3<4.7
where f1 is a focal length of the first lens unit.

8. The zoom lens according to claim 1, wherein the following inequality is satisfied:
1.47<nd3PA<1.71
where nd3PA is an average value of refractive indices for the d-line of all positive lenses included in the third lens unit.

9. The zoom lens according to claim 1, wherein the following inequality is satisfied:
48<νd3PA<85
wherein nd3PA is an average value of Abbe numbers of all positive lenses included in the third lens unit.

10. The zoom lens according to claim 1, wherein the following inequality is satisfied:
0.01<|f2/ft|<0.15
where f2 is a focal length of the second lens unit.

11. The zoom lens according to claim 1, wherein the following inequality is satisfied:
4.5<|f1/f2|<10.0
where f1 is a focal length of the first lens unit, and f2 is a focal length of the second lens unit.

12. The zoom lens according to claim 1, wherein the following inequality is satisfied:
0.01<skt/ft<0.25
where skt is a back focus of the zoom lens at the telephoto end, and ft is a focal length of the zoom lens at the telephoto end.

13. The zoom lens according to claim 1, wherein at least one of the three lens elements included in the third lens unit is a cemented lens.

14. The zoom lens according to claim 13, wherein one of the three lens elements included in the third lens unit, which is disposed closest to an object is a cemented lens consisting of a negative lens and a positive lens arranged in order from the object side to the image side.

15. The zoom lens according to claim 1, wherein the first lens unit consists of, in order from the object side to the image side, a cemented lens of a negative lens and a positive lens, and two single lenses each having positive refractive power.

16. The zoom lens according to claim 1, wherein the second lens unit consists of four spherical lenses, and
wherein the four spherical lenses include, in order from the object side, a negative lens, a negative lens, a positive lens, and a negative lens.

17. The zoom lens according to claim 1, wherein the second lens unit consists of four spherical lenses, and
wherein the four spherical lenses include, in order from the object side, a negative lens, a negative lens, a negative lens, and a positive lens.

18. The zoom lens according to claim 1, wherein the third lens unit consists of, in order from the object side to the image side, a first subunit and a second subunit that are spaced by a largest air gap, and
wherein the second subunit consists of one negative lens and two positive lenses.

19. The zoom lens according to claim 1, wherein a lens unit disposed closest to the image plane of the zoom lens is fixed relative to the image plane during zooming.

20. The zoom lens according to claim 1, wherein the four or more lens units consist of, in order from the object side to the image side, the first lens unit, the second lens unit, the third lens unit, a fourth lens having negative refractive power, and a fifth lens unit having positive refractive power.

21. The zoom lens according to claim 1, wherein the four or more lens units consist of, in order from the object side to the image side, the first lens unit, the second lens unit, the third lens unit, a fourth lens having negative refractive power, a fifth lens unit having positive refractive power, and a sixth lens unit.

22. An image pickup apparatus comprising:
a zoom lens; and
an image sensor configured to receive an image formed by the zoom lens,
wherein the zoom lens includes four or more lenses that include, in order from an object side to an image side, a first lens unit having positive refractive power, a second lens unit having negative refractive power, and a third lens unit having positive refractive power,
wherein a distance between adjacent lens units changes during zooming from a wide-angle end to a telephoto end,
wherein for zooming from the wide-angle end to the telephoto end, the first lens unit and the third lens unit are fixed relative to an image plane, and the second lens unit moves toward the image side,
wherein the third lens unit includes three lens elements each having positive refractive power, and
wherein the following inequalities are satisfied:
0.005<f3/ft<0.150
1.902<nd3u<2.300
−0.50<β2w<−0.01
where f3 is a focal length of the third lens unit, ft is a focal length of the zoom lens at the telephoto end, nd3u is a maximum value among refractive indices for d-line of lenses included in the third lens unit, and β2w is a lateral magnification of the second lens at the wide-angle end.
